(19) United States
(12) Patent Application Publication
(10) Pub. No.: US 2024/0412122 A1
(43) Pub. Date: Dec. 12, 2024

(54) SYSTEMS AND METHODS FOR PROVIDING FITNESS FUNCTION VISUALIZATIONS

(71) Applicant: Verint Americas Inc., Alpharetta, GA (US)

(72) Inventors: John Richard O'Farrell, Huntsville, AL (US); Jonathan Silverman, Palo Alto, CA (US)

(21) Appl. No.: 18/741,276

(22) Filed: Jun. 12, 2024

Related U.S. Application Data
(60) Provisional application No. 63/507,489, filed on Jun. 12, 2023.

(51) Int. Cl. G06Q 10/04; G06F 17/18

(52) U.S. Cl. CPC G06Q 10/04; G06F 17/18

(57) ABSTRACT

Embodiments of the present disclosure provide systems and methods for generating a plurality of forecasts for a future time interval using a plurality of models and/or algorithms in order to assess the performance of each model. An example computer-implemented method can comprise generating a fitness function visualization corresponding with determined quantitative measures of forecast quality for each of the plurality of models and/or algorithms.

### CROSS-REFERENCE TO RELATED APPLICATIONS

This application claims priority to and the benefit of U.S. Provisional Application No. 63/507,489, titled “SYSTEMS AND METHODS FOR PROVIDING FITNESS FUNCTION VISUALIZATIONS,” filed on Jun. 12, 2023, the content of which is incorporated by reference herein in its entirety.

### BACKGROUND

In many industries forecasting is used to predict demand for a particular time period or time interval. For example, a call center may develop forecasts to predict call volumes for particular time intervals, and the predicted call volumes may be used to determine the number of agents that should be scheduled to handle the predicted call volumes to maintain a desired service level. Other customer service entities such as back-office operations centers and retail branch offices of banks employ similar forecasting techniques to predict future demands.

### SUMMARY

Embodiments of the present disclosure provide systems and methods for providing fitness function visualizations for a plurality of forecasting algorithms that can be used to compare and assess model performance.

Customer service centers face the challenge of accurately forecasting future demand for their services. Traditional approaches provide a single forecast score without sufficient context, making it difficult for users to understand the strengths and weaknesses of different algorithms. For example, in the customer service center forecasting space, existing solutions offer forecasting algorithms that generate single forecast scores, if the performance is revealed to the user at all. These scores provide a limited understanding of forecast performance, making it challenging for users to compare and select the most suitable algorithm. Additionally, the visualization of deviations within the forecast period is not commonly practiced. This lack of transparency hinders the decision-making process when selecting the most appropriate forecasting algorithm for specific requirements. Generally, forecasts are determined using historical data. The historical data may include data indicating the demand measured at certain time intervals in the past. For call centers, the historical data may include the call volume measured at various time intervals at the call center.

However, there are drawbacks associated with forecasting using historical data alone. Existing approaches provide a narrow view of forecast performance, lacking the ability to showcase the distribution and patterns of deviations within the forecast period. Users may be left with a single score that does not provide insights into the strengths and weaknesses of each algorithm. This limits their ability to make informed decisions and select the algorithm that aligns best with their specific needs.

Embodiments of the present disclosure provide a comprehensive approach to customer service center forecasting that combines different forecasting algorithms with visualizations of their performance. In some implementations, forecasts are generated using various algorithms and evaluated using fitness functions such as root-mean-square-error (RMSE) and mean absolute percentage error (MAPE). In various examples, the visualizations provide a distribution chart that highlights the volume of deviations within the forecast period, allowing users to easily understand the forecast performance and choose the algorithm that best suits their needs.

Embodiments of the present disclosure combine different forecasting algorithms with the visualizations of their performance. By presenting, for example, a distribution chart that shows the volume of deviations within the forecast period, users gain a deeper understanding of the forecast behavior. This empowers them to make informed decisions and select the algorithm that aligns with their preferences and priorities, such as focusing on outliers or near misses. In some implementations, an optimized model can be automatically deployed to address identified preferences and needs without human input.

Embodiments of the present disclosure offer a unique competitive advantage compared to existing solutions in the customer service center forecasting space. While others provide only a single forecast score, the systems and methods described herein provide comprehensive visualizations that present the distribution of deviations. This context-rich representation allows users to evaluate forecast performance based on their specific requirements, considering factors like outliers or near misses. By enabling users to make informed decisions about algorithm selection, embodiments of the present disclosure provide transparency and flexibility to the forecasting process. Additionally, the accuracy of forecasts made using the models that are selected, refined, and/or identified using the disclosed systems and methods are more accurate.

In some implementations, the techniques described herein relate to a computer-implemented method for generating a fitness function visualization, the computer-implemented method including: receiving, by computing device, historical data for an entity, wherein the historical data includes a plurality of historical time intervals and demand data measured for each time interval of the plurality of historical time intervals; generating, by the computing device, a plurality of forecasts for a future time interval using a plurality of models or algorithms; evaluating, by the computing device, the plurality of forecasts using one or more fitness functions; determining, by the computing device, a quantitative measure of forecast quality for each of the plurality of forecasts; and outputting, by the computing device, the fitness function visualization corresponding with the determined quantitative measures of forecast quality.

In some implementations, the techniques described herein relate to a system for generating a fitness function visualization, the system including: at least one computing device; and a computer-readable medium storing instructions that when executed by the at least one computing device, cause the at least one computing device to: receive historical data for an entity, wherein the historical data includes a plurality of historical time intervals and demand data measured for each time interval of the plurality of historical time intervals; generate a plurality of forecasts for a future time interval using a plurality of models or algorithms; evaluate the plurality of forecasts using one or more fitness functions; determine a quantitative measure of forecast quality for each of the plurality of forecasts; and output the fitness function visualization corresponding with the determined quantitative measures of forecast quality.

In some implementations, the techniques described herein relate to a non-transitory computer readable medium including instructions that, when executed by a processor of a processing system, cause the processing system to perform a method for generating a fitness function visualization, including instructions to: receive historical data for an entity, wherein the historical data includes a plurality of historical time intervals and demand data measured for each time interval of the plurality of historical time intervals; generate a plurality of forecasts for a future time interval using a plurality of models or algorithms; evaluate the plurality of forecasts using one or more fitness functions; determine a quantitative measure of forecast quality for each of the plurality of forecasts; and output the fitness function visualization corresponding with the determined quantitative measures of forecast quality.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an exemplary environment for generating fitness function visualizations;

FIG. 2 is an operational flow of an implementation of a method for generating fitness function visualizations;

FIG. 3 is an illustration of a screenshot of a graphical user interface for presenting fitness function visualizations to a user; and

FIG. 4 shows an exemplary computing environment in which example embodiments and aspects may be implemented.

### DETAILED DESCRIPTION

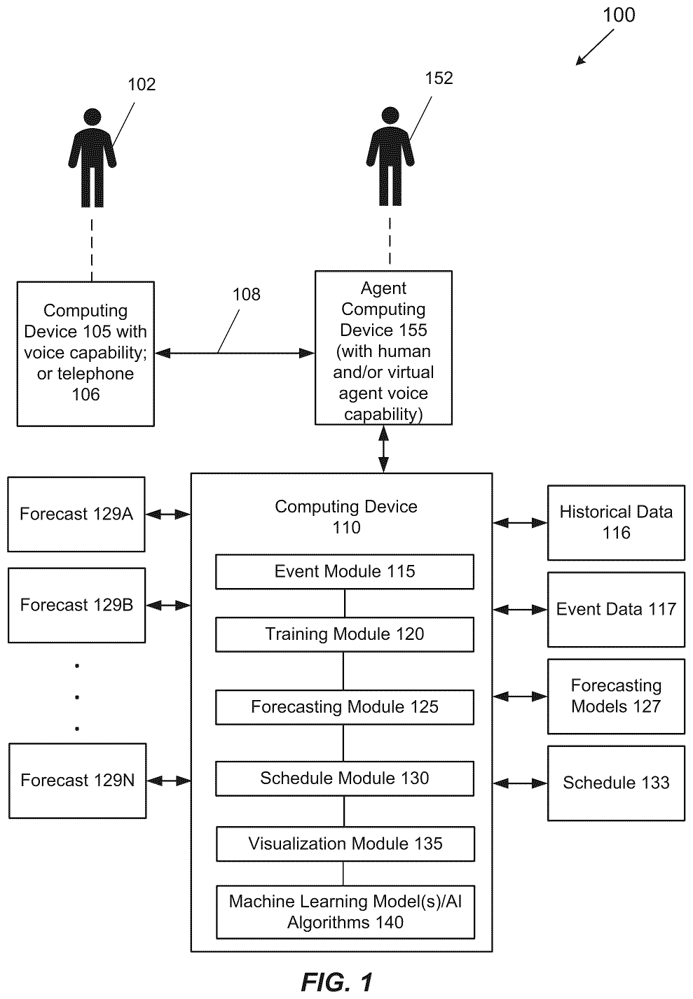

FIG. 1 is an illustration of an environment 100 for generating and providing fitness function visualizations, for example, for comparing the performance of a plurality of forecast models. The environment 100 may be implemented by a call center or any other entity that receives calls (or chats, electronic communications, or face-to-face in person communications) from customers or clients. A customer 102 may use a computing device 105 (or a telephone 106) to initiate a call with an agent 152 associated with the environment 100. The agent 152 may receive the call via a channel 108 such as a Voice over Internet Protocol (VOIP) line, plain old telephone service (POTS) line, or a cellular channel. Any channel suitable for voice communication may be used.

The agent 152 may receive the call from the customer 102 or an agent computing device 155. The agent computing device 155 may be equipped with both human and virtual voice agent capabilities.

Besides the agent 152, the call may also be received (at the same time or later) by a computing device 110 associated with the call center environment 100. The computing device 110 may provide one or more call center services to the customer 102 such as interactive voice response services (“IVR”) where the user may be presented with an automated system that may determine the optimal agent 152 to direct the call, may determine the identity of the customer 102, or may retrieve other information from the customer 102 in an automated way.

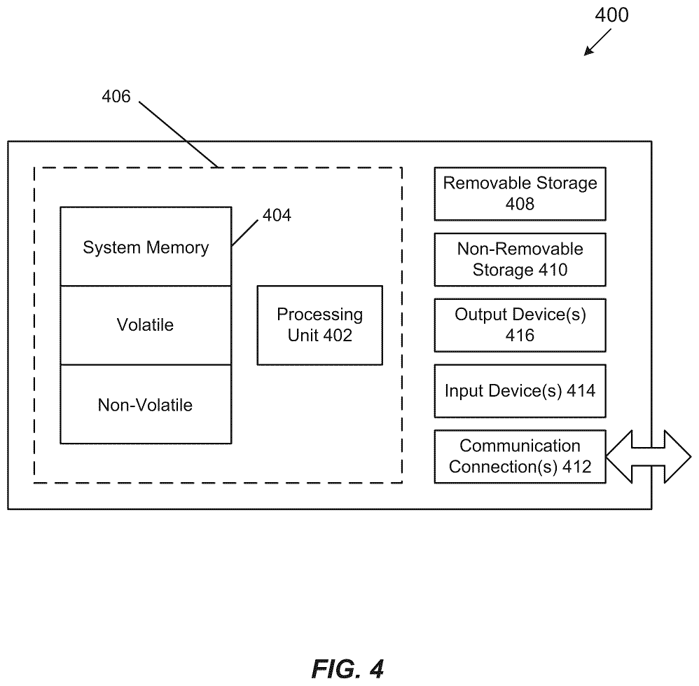

As may be appreciated, the computing device 105, agent computing device 155, and the computing device 110 may each be implemented by one or more general purpose computing devices such as the computing device 400 illustrated in FIG. 4. Depending on the embodiment, the computing device 110 may be part of a voice recorder or other device performing functions in a call center. Note that the embodiments described herein are not limited to calls but may apply to any type of electronic communications that may be handled by an agent 152 in a call center such as emails, chats, tweets, etc.

Furthermore, the embodiments are not limited to call center applications and may be used in a variety of scenarios and locations including, but not limited to, back offices, retail environments, bank branches, etc. In such scenarios, the communications may include any type of electronic and physical communications including face-to-face communications.

As described above, in order to determine a number of agents 152 to use for an entity, the computing device 110 may generate a plurality of forecasts 129A-N for one or more future time intervals. Depending on the embodiment, each time interval may be approximately 15 minutes in length. Other size time intervals including but not limited to hours, days, weeks, months or years may be used.

Each forecast 129A-N for a future time interval may indicate the demand that is expected to be received by an entity (e.g., call center, back office or retail branch) during the time interval. The demand may include statistics such as call volume, average handling time, and shrinkage. In addition, the demand may include demand for specific types of communications that may be received by the entity including but not limited to phone calls, emails, and chats, electronic work items, physical mail and face to face interactions. Other types of communications may be supported.

In some embodiments, a forecasting module 125 may generate a plurality of forecasts 129A-N for a specified time interval using a plurality of models or algorithms. The generated forecasts 129A-N may be evaluated using one or more fitness functions or tests. For example, the computing device 110 can determine a quantitative measure of forecast quality for each of the plurality of forecasts in order to identify the best performing model or algorithm. The visualization module 135 may generate and output a fitness function visualization corresponding with the determined measures quantitative measures of forecast quality. Subsequently, the schedule module 130 may generate a schedule 133 for the entity for the future interval based at least in part on the forecast generated by the best performing model or algorithm. The schedule 133 may assign agents 152 to one or more queues for a future interval in a way that will meet one or more service goals for the queues given the generated forecast 129. The service goal may include an average wait time for callers to the entity. Other service goals may be supported.

The forecasting module 125 may generate a plurality of forecasts 129A-N using a plurality of forecasting models 127 that were trained to generate forecasts 129 for intervals based on historical data 116. The historical data 116 may include measured demand for the call center from past intervals. The measured demand for a past interval may include the call volume received at the entity for the past interval. Other data indicative of demand may be included. In some implementations, the historical data 116 includes Work Force Management (WFM) System data and/or externally sourced data.

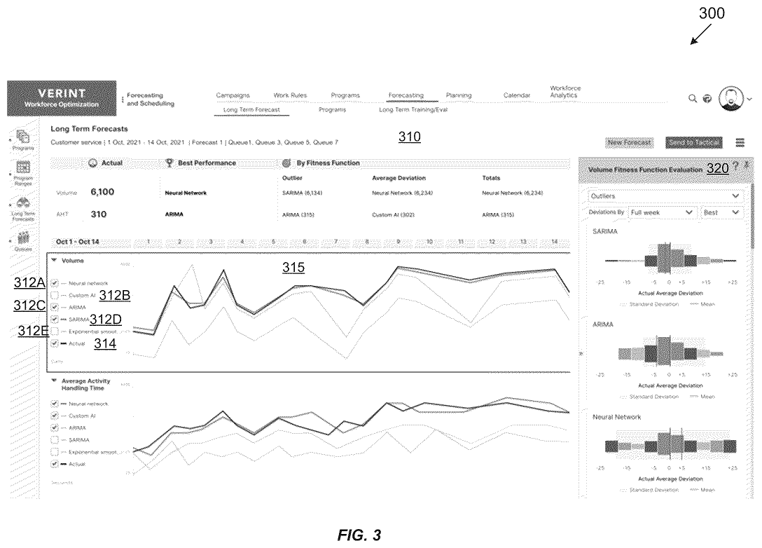

In some embodiments, the forecasting module 125 may generate the plurality of forecasting models 127 using a variety of methods including machine learning and statistical methods. Each of the plurality of forecasting models 127 may be trained with a different set of historical data 116 or using different weights and/or heuristics. Various types of prediction model may be used. In some implementations, the computing device 110 includes one or more machine learning model(s) and/or artificial intelligence (AI) algorithms that can be used to generate the forecasting models 127. In some embodiments, the one or more machine learning model(s) or AI algorithms 140 are a component of the forecasting module 125.

Where multiple forecasting models 127 are available, in some embodiments, the forecasting module 125 may allow a user or administrator to compare the forecasts 129A-N generated by each of the plurality of forecasting models 127. For example, the forecasts 129 may be displayed to the administrator in a graphical user interface such as the graphical user interface 300 of FIG. 3. For example, the visualization module 135 can generate a fitness function visualization corresponding with determined quantitative measures of forecast quality. The user or administrator may then select one of the plurality of forecasting models 127 whose forecast that they would like to use.

In addition, in some embodiments, the forecasting module 125 may track the historical performance of each of the plurality of forecasting models 127 over time by comparing its forecasts 129A-N for intervals to the actual demand experienced by the entity for the intervals. The forecasting module 125 may then recommend the best performing model of the plurality of forecasting models 127 to the administrator. As may be appreciated, because of different businesses or organizations associated with each entity (e.g., call center), some forecasting models 127 may perform better for different entities than other forecasting models 127.

In addition, to further improve the performance of forecasting models 127, the training module 120 may further consider event data 117 when training one or more forecasting modules 125. Event data 117 as used herein may be data, or data points, that relates to an event or happening that may affect the demand predicted by the forecasting module 125 for an interval. Example events may include events that are external to an entity such as sporting events, movie or television premiers, political events, weather events, financial events (e.g., stock increases or decreases, and earnings reports) and product release schedules of other entities. Other types of external events may be included.

The event data 117 may further include events that are internal to an entity. These internal events may include product releases of the entity, sales or marketing promotions run by the entity, and financial events related to the entity. The internal events may further include information about the types of calls being received by the entity. For example, if the entity is receiving a larger than normal amount of complaints for a current interval, this may indicate that a larger call volume may be expected for a future interval.

As may be appreciated, the particular event data 117 that affects the demand for an entity may be dependent on a variety of factors such as a location of the entity or the industry associated with the entity. For example, an insurance company that serves North America may experience demand that is highly affected by weather conditions in certain zip codes. As another example, an entity that sells sporting goods may experience reduced demand when certain professional sporting events are taking place. In still another example, an entity that provides a stock trading application for smart phones may experience increased demand when the stock market is experiencing larger than normal losses or gains.

The event data 117 (historical and future) may be collected by the event module 115 from a variety of sources. These sources may include news feeds, weather feeds, and sports feeds, product release schedules, stock market data feeds, and the like. Other sources may be used. In addition, the event data 117 may be received from the call center itself and may include event data 117 describing the category or sentiment of the calls or communications that have been received so far. For example, the event module 115 may receive data indicative of a sentiment analysis performed on some of all of the communications received by the entity.

In some embodiments, the data indicative of a sentiment analysis may include intelligence generated by one or more speech and/or text analysis application performed on communications received by the entity. For example, the speech and/or text application may process received communications and may determine that there has been a spike in negative calls or communications, or that the number of communications for technical support are less than expected for a current interval. Such information may indicate that future demand or work volume received by the entity for an upcoming interval may be less than (or more than) expected.

The training module 120 may receive the event data 117 and may train each forecasting model 127 to generate a respective forecast of the plurality of forecasts 129A-N using both the historical data 116 and the event data 117. Each forecasting model 127 may take as an input collected event data 117 for a future interval and an identifier of the future interval and may generate a respective forecast of the plurality of forecasts 129A-N for the future interval that considers the event data 117 for that interval.

In some embodiments, the training module 120 may analyze the historical data 116 for a plurality of past intervals, and the event data 117 for those intervals, to determine which particular events are relevant for the entity associated with the call center. For example, an event such as an awards show on television may not significantly change the call demand for an entity such as a bank, but an event such as a change in interest rates by the federal reserve bank may. The training module 120 may determine those events that have an impact on demand for an entity using machine learning, for example.

In some embodiments, the training module 120 may train a plurality of forecasting models 127 that each output an expected change in demand for an entity at a future interval due to events occurring during the interval as indicated by the event data 117. The forecasts 129A-N for such a future interval may then be determined by adding (or subtracting) the change in demand predicted by each of the plurality of forecasting models 127 trained using the event data from the demand predicted by each of the plurality of forecasting models 127 that were trained using the historical data 116 alone.

As noted above, the visualization module 135 can generate and output a fitness function visualization corresponding with determined quantitative measures of forecast quality for each of the plurality of forecasting models 127. A user or administrator can view the fitness function visualization via a graphical user interface, such as the graphical user interface 300 depicted in FIG. 3. The user or administrator may then select one of the plurality of forecasting models 127 for use. By way of example, based on the outputs of the chosen forecasting model, the user or administrator can generate or update a schedule 133 for a future time interval.

The schedule module 130 generates a schedule 133 using a selected forecast from the plurality of forecasts 129A-N generated by the forecasting module 125 for a plurality of further intervals. For example, the schedule module 130 may generate a schedule 133 for two weeks of time intervals for the call center. A schedule 133 may assign agents 152 to one or more queues for each interval of the plurality of intervals.

In some embodiments, the schedule module 130 may change or modify schedules for future intervals as new event data 117 is received. For example, events such as weather or stock prices may change rapidly or unexpectedly leading to a change in the selected forecast of the plurality of forecasts 129A-N for an upcoming interval. Accordingly, as new event data 117 is received for a future interval, the forecasting module 125 may regenerate a particular forecast for the given interval, and if the forecasted demand changes, the schedule module 130 may update or revise the schedule 133 for that interval.

### Generation of Forecasts

Embodiments of the present disclosure implement a framework that incorporates multiple forecasting algorithms, each utilizing unique methodologies such as time series analysis, machine learning, or statistical modeling. These algorithms are applied to historical data to generate forecasts for future customer service center demand. This disclosure contemplates that a variety of machine learning and/or artificial intelligence approaches can be used to implement the embodiments described herein, including, but not limited to, artificial neural networks, convolutional neural networks (CNNs), Naïve Bayes' (NB) classifiers, k-nearest neighbors (k-NN) classifiers, supervised or semi-supervised machine learning models, transformer-based models, and/or the like, as described in more detail herein. For example, a trained machine learning model can be employed to generate forecasts. The machine learning model can be trained using data associated with one or more entities or one or more types of entities in order to improve and optimize the accuracy of the generated forecasts.

### Evaluation and Visualization of Performance

To evaluate the performance of the forecasts, fitness functions such as root-mean-square-error (RMSE) and mean absolute percentage error (MAPE) are employed. These functions quantify the accuracy of each forecast by comparing it against the actual customer service center demand. The resulting scores provide a quantitative measure of forecast quality.

To provide a more intuitive and comprehensive understanding of forecast performance, visualization techniques are introduced. One of these visualizations is a distribution chart, which represents the volume of deviations within the forecast period. In some implementations, each bar in the chart corresponds to a specific range of deviations from the average. The size of the bar can indicate the number of days that fell within that deviation range, and the color can indicate the distance each deviation category is from 0. The user can choose to see the distributions across the full week, or by choosing any combination of days of the week to see how the deviations happened on those days during the forecast period. By analyzing the distribution chart, users can identify patterns, outliers, and the overall behavior of the forecasts.

The entire process is designed to be flexible and customizable, allowing users to select and compare different forecasting algorithms and fitness functions. The visualizations provide a holistic view of forecast performance, enabling users to make informed decisions based on their specific needs and preferences.

Overall, embodiments of the present disclosure combine the utilization of multiple forecasting algorithms with the visualization of their performance, enabling customer service center operators to gain insights and select the most suitable algorithm for their forecasting requirements.

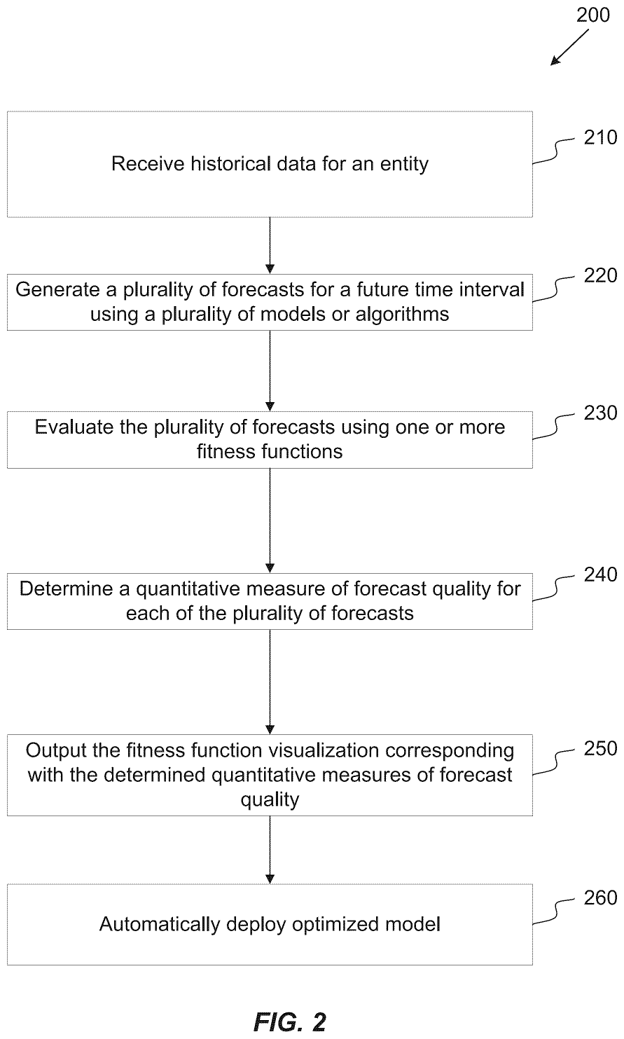

With reference to FIG. 2, embodiments of the present disclosure include operations for generating a fitness function visualization with respect to a plurality of models and/or algorithms. The computer-implemented method 200 illustrated in FIG. 2 can be implemented using some or all of the system components illustrated with reference to FIG. 1.

At step 210, the computing device (e.g., computing device 110 described above in connection with FIG. 1) receives (e.g., retrieves, obtains) historical data for an entity. The entity may be or comprise a call center, a retailer, or a back office. The historical data can comprise a plurality of historical time intervals and demand data measured for each time interval of the plurality of historical time intervals.

At step 220, the computing device generates a plurality of forecasts for a future time interval using a plurality of models or algorithms. In some embodiments, the plurality of models or algorithms comprise at least one of time series analysis, a machine learning model, or a statistical model.

At step 230, the computing device evaluates the plurality of forecasts using one or more fitness functions. In some implementations, the computing device evaluates the plurality of forecasts by employing at least one of an RMSE, a MAPE function, or other fitness function.

At step 240, the computing device determines a quantitative measure of forecast quality for each of the plurality of forecasts. In some embodiments, the computing device determine the quantitative measure of forecast quality for each of the plurality of forecasts by quantifying accuracy of each forecast by comparing it against actual customer service center demand. The demand data measured for each time interval can comprise a call volume, average handling time, and/or shrinkage.

At step 250, the computing device outputs the fitness function visualization corresponding with the determined quantitative measures of forecast quality. In some implementations, the fitness function visualization comprises at least one of a distribution chart representing a volume of deviations within the future time interval for each of the plurality of models or algorithms, a recommendation, or a report.

In some implementations, at step 260, the computing device automatically deploys an optimized model for the user. For example, the computing device can automatically select and/or deploy a best-performing or optimized model for a particular application or determined context. In other embodiments, the computing device can receive an indication of a user-selected model from the plurality of models or algorithms and can deploy the user-selected model for use.

This disclosure contemplates that the method 200 described above can be used to assess demand data, shrinkage, combinations thereof, and/or the like (e.g., to forecast shrinkage).

### Artificial Intelligence and Machine Learning

The term “artificial intelligence” is defined herein to include any technique that enables one or more computing devices or comping systems (i.e., a machine) to mimic human intelligence. Artificial intelligence (AI) includes, but is not limited to, knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders. The term “deep learning” is defined herein to be a subset of machine learning that enables a machine to automatically discover representations needed for feature detection, prediction, classification, etc. using layers of processing. Deep learning techniques include, but are not limited to, artificial neural networks or a multilayer perceptron (MLP).

Machine learning models include supervised, semi-supervised, and unsupervised learning models. In a supervised learning model, the model learns a function that maps an input (also known as feature or features) to an output (also known as target or targets) during training with a labeled data set (or dataset). In an unsupervised learning model, the model learns patterns (e.g., structure, distribution, etc.) within an unlabeled data set. In a semi-supervised model, the model learns a function that maps an input (also known as feature or features) to an output (also known as target or target) during training with both labeled and unlabeled data.

Artificial Neural Networks. An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers such as input layer, output layer, and optionally one or more hidden layers. An ANN having hidden layers can be referred to as deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanH, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include, but are not limited to, backpropagation. It should be understood that an artificial neural network is provided only as an example machine learning model. This disclosure contemplates that the machine learning model can be any supervised learning model, semi-supervised learning model, or unsupervised learning model. Optionally, the machine learning model is a deep learning model.

Convolutional Neural Networks. A convolutional neural network (CNN) is a type of deep neural network that has been applied, for example, to image analysis applications. Unlike a traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully-connected layer includes neurons, where each neuron is connected to all of the neurons in the previous layer. The layers are stacked similar to traditional neural networks.

Naïve Bayes. A Naïve Bayes' (NB) classifier is a supervised classification model that is based on Bayes' Theorem, which assumes independence among features (i.e., presence of one feature in a class is unrelated to presence of any other features). NB classifiers are trained with a data set by computing the conditional probability distribution of each feature given label and applying Bayes' Theorem to compute conditional probability distribution of a label given an observation. NB classifiers are known in the art and are therefore not described in further detail herein.

k-nearest neighbors (k-NN) classifier. A k-NN classifier is a supervised classification model that classifies new data points based on similarity measures (e.g., distance functions). k-NN classifier is a non-parametric algorithm, i.e., it does not make strong assumptions about the function mapping input to output and therefore has flexibility to find a function that best fits the data. k-NN classifiers are trained with a data set (also referred to herein as a “dataset”) by learning associations between all samples and classification labels in the training dataset. k-NN classifiers are known in the art and are therefore not described in further detail herein.

Embodiments of the present disclosure can be divided into two main components: the generation of forecasts using different algorithms and the visualization of their performance.

FIG. 3 is an illustration of an example graphical user interface 300 that may be used by an administrator to view forecasts 129 and interact with the computing device 110.

As shown, the graphical user interface comprises a window 310 through which a user or administrator can view a plurality of forecasts generated using a plurality of forecasting models 312A, 312B, 312C, 312D, and 312E for one or more intervals. In the example shown, the interval is “October 1-October 14” and each of the plurality of forecasts generated using the plurality of forecasting models 312A, 312B, 312C, 312D, and 312E corresponds with a line on a graph 315. Additionally, actual demand information 314 for the interval is included in the graph 315 for comparison. Each of the plurality of forecasts can comprise a predicted call volume, a predicted average handling time, and/or the like. Within the window 310 the administrator can select different days to view the predicted demand or can select different time intervals in which to view the demand (e.g., day, week, or period).

The graphical user interface 300 further includes a second window 320 through which the administrator can view a volume fitness function evaluation for the plurality of forecasting models 312A, 312B, 312C, 312D, and 312E. In the example shown in FIG. 3, the volume fitness function evaluation comprises distribution charts that each correspond with a forecasting model and represent a volume of deviations within the forecast period. Each bar in each chart corresponds to a specific range of deviations from the average. The size of the bar can indicate the number of days that fell within that deviation range, and the color can indicate the distance each deviation category is from 0. The user can choose to see the distributions across the full week, or by choosing any combination of days of the week to see how the deviations happened on those days during the forecast period. By analyzing the distribution chart, users can identify patterns, outliers, and the overall behavior of the forecasts.

In some embodiments, the graphical user interface 300 may allow an administrator, or other user, to add (and modify) their own forecasting models or other algorithms. For example, an entity such as bank may add a forecasting model that specifically forecasts demand for bank branches. In another example, an entity such as a back office may add a forecasting model that considers a linkage between tasks in a process. The forecasting model selected by an entity may be focused on forecasting the types of demand that are relevant to the entity (e.g., in person visits versus phone calls) and consider the types of employees associated with the entity (e.g., agents versus salespersons). The plurality of forecasting models 312A, 312B, 312C, 312D, and 312E may be generated by the entities themselves or sold or otherwise provided to the entities.

FIG. 4 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 4, an exemplary system for implementing aspects described herein includes a computing device, such as computing device 400. In its most basic configuration, computing device 400 typically includes at least one processing unit 402 and memory 404. Depending on the exact configuration and type of computing device, memory 404 may be volatile (such as random-access memory (RAM)), non-volatile (such as read-only memory (ROM), flash memory, etc.), or some combination of the two. This most basic configuration is illustrated in FIG. 4 by dashed line 406.

Computing device 400 may have additional features/functionality. For example, computing device 400 may include additional storage (removable and/or non-removable) including, but not limited to, magnetic or optical disks or tape. Such additional storage is illustrated in FIG. 4 by removable storage 408 and non-removable storage 410.

Computing device 400 typically includes a variety of computer readable media, such as a non-transitory computer readable medium or computer-readable medium storing instruction for execution. Computer readable media can be any available media that can be accessed by the device 400 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 404, removable storage 408, and non-removable storage 410 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 400. Any such computer storage media may be part of computing device 400.

Computing device 400 may contain communication connection(s) 412 that allow the device to communicate with other devices. Computing device 400 may also have input device(s) 414 such as a keyboard, mouse, pen, voice input device, touch input device, etc. Output device(s) 416 such as a display, speakers, printer, etc. may also be included. All these devices are well known in the art and need not be discussed at length here.

The computing device 400 can be a computer system that includes various kinds of software programs, data stores, and hardware according to certain embodiments. The computing system can include, without limitation, a central processing unit (CPU), a network interface, and a memory, each connected to a bus. The computing system may also include an I/O device interface connecting I/O devices (e.g., keyboard, display, and mouse devices) to the computing system. Further, the computing elements shown in computing system may correspond to a physical computing system (e.g., a system in a data center) or may be a virtual computing instance executing within a computing cloud.

The CPU can retrieve and executes programming instructions stored in memory. The bus can be used to transmit programming instructions and application data between the CPU, I/O device interface, network interface, and memory. The CPU can comprise a single CPU, multiple CPUs, a single CPU having multiple processing cores, and the like, and the memory is generally included to be representative of random-access memory. The memory may also be a disk drive or flash storage device. The memory may be a combination of fixed and/or removable storage devices, such as fixed disc drives, removable memory cards, optical storage, network-attached storage (NAS), or a storage area network (SAN).

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A computer-implemented method for generating a fitness function visualization, the computer-implemented method comprising:
receiving, by computing device, historical data for an entity, wherein the historical data comprises a plurality of historical time intervals and demand data measured for each time interval of the plurality of historical time intervals;
generating, by the computing device, a plurality of forecasts for a future time interval using a plurality of models or algorithms;
evaluating, by the computing device, the plurality of forecasts using one or more fitness functions;
determining, by the computing device, a quantitative measure of forecast quality for each of the plurality of forecasts; and
outputting, by the computing device, the fitness function visualization corresponding with the determined quantitative measures of forecast quality.

2. The computer-implemented method of claim 1, further comprising:
receiving, by the computing device, an indication of a user-selected model from the plurality of models or algorithms; and
deploying, by the computing device, the user-selected model.

3. The computer-implemented method of claim 1, wherein the fitness function visualization comprises at least one of a distribution chart representing a volume of deviations within the future time interval for each of the plurality of models or algorithms, a recommendation, or a report.

4. The computer-implemented method of claim 1, wherein evaluating the plurality of forecasts comprises:
employing, by the computing device, at least one of a root-mean-square-error function (RMSE) and a mean absolute percentage error (MAPE) function, or other fitness function.

5. The computer-implemented method of claim 1, wherein the plurality of models or algorithms comprises at least one of a time series analysis, a machine learning model, or a statistical model.

6. The computer-implemented method of claim 1, wherein determining a quantitative measure of forecast quality for each of the plurality of forecasts comprises quantifying accuracy of each forecast by comparing it against actual customer service center demand.

7. The computer-implemented method of claim 1, wherein the entity comprises one of a call center, a retailer, or a back office.

8. The computer-implemented method of claim 1, wherein the demand data measured for each time interval comprises at least one of a call volume, average handling time, or shrinkage.

9. A system for generating a fitness function visualization, the system comprising:
at least one computing device; and
a computer-readable medium storing instructions that when executed by the at least one computing device, cause the at least one computing device to:
receive historical data for an entity, wherein the historical data comprises a plurality of historical time intervals and demand data measured for each time interval of the plurality of historical time intervals;
generate a plurality of forecasts for a future time interval using a plurality of models or algorithms;
evaluate the plurality of forecasts using one or more fitness functions;
determine a quantitative measure of forecast quality for each of the plurality of forecasts; and
output the fitness function visualization corresponding with the determined quantitative measures of forecast quality.

10. The system of claim 9, further comprising instructions that when executed by the at least one computing device, cause the at least one computing device to:
receive an indication of a user-selected model from the plurality of models or algorithms; and
deploy the user-selected model.

11. The system of claim 9, wherein the fitness function visualization comprises at least one of a distribution chart representing a volume of deviations within the future time interval for each of the plurality of models or algorithms, a recommendation, or a report.

12. The system of claim 9, further comprising instructions that when executed by the at least one computing device, cause the at least one computing device to evaluate the plurality of forecasts by:
employing at least one of a root-mean-square-error function (RMSE), a mean absolute percentage error (MAPE) function, or other fitness function.

13. The system of claim 9, wherein the plurality of models or algorithms comprises at least one of a time series analysis, a machine learning model, or a statistical model.

14. The system of claim 9, further comprising instructions that when executed by the at least one computing device, cause the at least one computing device to determine the quantitative measure of forecast quality for each of the plurality of forecasts by:
quantifying accuracy of each forecast by comparing it against actual customer service center demand.

15. The system of claim 9, wherein the entity comprises one of a call center, a retailer, or a back office.

16. The system of claim 9, wherein the demand data measured for each time interval comprises at least one of a call volume, average handling time, or shrinkage.

17. A non-transitory computer readable medium comprising instructions that, when executed by a processor of a processing system, cause the processing system to perform a method for generating a fitness function visualization, comprising instructions to:
receive historical data for an entity, wherein the historical data comprises a plurality of historical time intervals and demand data measured for each time interval of the plurality of historical time intervals;
generate a plurality of forecasts for a future time interval using a plurality of models or algorithms;
evaluate the plurality of forecasts using one or more fitness functions;
determine a quantitative measure of forecast quality for each of the plurality of forecasts; and
output the fitness function visualization corresponding with the determined quantitative measures of forecast quality.

18. The non-transitory computer readable medium of claim 17, further comprising instructions that, when executed by the processor of the processing system, cause the processing system to:
receive an indication of a user-selected model from the plurality of models or algorithms; and
deploy the user-selected model.

19. The non-transitory computer readable medium of claim 17, wherein the fitness function visualization comprises at least one of a distribution chart representing a volume of deviations within the future time interval for each of the plurality of models or algorithms, a recommendation, or a report.

20. The non-transitory computer readable medium of claim 17, further comprising further comprising instructions that, when executed by the processor of the processing system, cause the processing system to evaluate the plurality of forecasts by:
employing at least one of an RMSE function, a MAPE function, or other fitness function.
